(19) United States
(12) Patent Application Publication
(10) Pub. No.: US 2012/0022696 A1
(43) Pub. Date: Jan. 26, 2012

(54) DEVICE FOR CONTROLLING THE MOVEMENT OF A SURGICAL INSTRUMENT

(75) Inventors: Ameziane Aoussat, Montrouge (FR); Jean-Francois Omhover, Paris (FR); Alain Sezeur, Cachan (FR)

(73) Assignees: GROUPE HOSPITALIER DIACONESSES CROIX SAINT-SIMON, Paris (FR); ENSAM, CER DE PARIS, Paris (FR); UNIVERSITE PIERRE ET MARIE CURIE (PARIS 6), Paris (FR)

(21) Appl. No.: 13/131,690

(22) PCT Filed: Nov. 24, 2009
(86) PCT No.: PCT/FR2009/052280

§ 371 Date: Aug. 4, 2011

(30) Foreign Application Priority Data
Nov. 28, 2008 (FR) 0858092

(51) Int. Cl. G05B 15/02

(52) U.S. Cl. 700/275

(57) ABSTRACT

A control device includes an arm (12) for mounting an instrument and at least one motion sensor (16) to be placed on the operator (2) of the control device and equipped to sense the movement of the operator according to the degree of freedom of the mounting arm (12), the device including an element (20) for processing signals emitted by the motion sensor (16), the element (20) being equipped to process the signals emitted by the motion sensor (16) and to send the corresponding control signals to the mounting shaft (12) so that the movement sensed by the motion sensor (16) controls the corresponding movements of the mounting arm (12). The device also includes an element for starting and stopping the detection of the motion of the operator by the sensor (16).

The present invention relates to a device for controlling the movement of a surgical instrument, of the type comprising a mounting arm of the instrument and at least one motion sensor, said arm being able to move with at least one degree of freedom, said motion sensor being intended to be positioned on the operator of the control device and being arranged to sense the movements of said operator according to the degree of freedom of the mounting arm.

The invention more particularly applies to minimally invasive surgery, such as arthroscopy, laparoscopy or coelioscopy, or thoracoscopy. In this type of operation, incisions 5 to 10 mm long are formed in the patient's body and trocars are inserted into the incisions so as to allow the passage of surgical instruments in the patient's body. An imaging device, such as a camera, is also introduced into the patient's body so as to allow the surgeon to visualize the operating zone.

In order to have satisfactory visual comfort, the surgeon must himself manipulate the camera to follow, or even anticipate, the movements he imparts to the instruments. However, this manipulation of the camera requires the surgeon to use only one hand to manipulate the surgical instruments strictly speaking.

To offset this drawback, the manipulation of the camera can be entrusted to an assistant. This assistant is then responsible for centering the image on the surgical action, which involves having considerable knowledge of the operation and the surgeon's habits. Very substantial learning time is therefore needed for the assistant to correctly position the camera and anticipate the surgeon's movements during the operation.

In order to offset this drawback, automated systems for controlling the movements of the camera have been proposed, allowing the surgeon to move the camera while holding surgical instruments in both hands.

Such systems generally comprise a robotic mounting arm of the camera and the control means for controlling the movement of this arm according to the surgeon's instructions.

Document WO-96/09587 for example describes a control system with voice recognition making it possible to pilot a robotic arm. A microphone is used to gather the surgeon's vocal instructions. These instructions are analyzed and converted into control signals for controlling the movement of the robotic arm. In such a system, a large number of instructions must be provided to allow and control the movement of the camera in all desired directions and to adjust other movement parameters, such as the movement speed and/or amplitude of the robotic arm.

This large number of instructions is problematic. Technically, it complicates the voice command software used, which must store a large number of possibilities related to the vocal imprint of each surgeon using the system. In fact, during the use of such a system, frequent errors are observed in the interpretation of the instructions given by the surgeon by the voice recognition software, which forces the surgeon to repeat the instructions. Furthermore, the use of a large number of instructions can be bothersome for the surgeon, who needs considerable concentration to manipulate the surgical instruments. Lastly, the ambient noise in the operating room may hinder the acquisition of the surgeon's instructions, the instructions then not being able to be taken into account by the software.

Other control systems use a detection of the surgeon's movements to move the camera. In this way, a system is known in which the surgeon wears a headset provided with infrared sensors, the movements of the surgeon's head being detected and converted into corresponding movements of the robotic arms. Such a system requires means for starting the acquisition of the surgeon's movements so that only the movements intended to move the camera are taken into account. Such starting means are for example formed by a pedal actuated by the surgeon. The starting can be problematic for the surgeon, who must then coordinate the complex movements of his hands performing the operation and that of his foot to actuate the pedal. Furthermore, other surgical instruments use a pedal for their actuation, for example an electrosurgical unit. The incorporation of the starting pedal with other pedals may lead to confusion by the surgeon, who may actuate the wrong pedal, and increases the bulk in the operating room.

Furthermore, such systems are not very ergonomic or intuitive for surgeons, who must be able to separate the thought process to ensure the camera's movements from the thought process to ensure the movements of the surgical instruments in hand. Indeed, the surgeon must make a conscious effort to move the camera by performing movements or actions different from those making it possible to manipulate the surgical instruments, such as moving his head or emitting precise instructions. Such an effort reduces the surgeon's concentration and can harm the performance of the surgical operation.

One of the aims of the invention is to offset these drawbacks by proposing an ergonomic and intuitive device for controlling the movement of a surgical instrument, facilitating positioning of the instrument by the surgeon while leaving the surgeon's hands free to maneuver other instruments and ensuring precise movement of the instrument according to the surgeon's wishes.

To that end, the invention relates to a control device of the aforementioned type, wherein said device comprises means for processing signals emitted by the motion sensor, said means being arranged to process the signals emitted by the motion sensor and to transmit corresponding control signals to the mounting arm so that the movements sensed by the motion sensor control corresponding movements of the mounting arm, the device also comprising means for starting and stopping the detection of the operator's movements by the sensor.

According to one feature of the invention, the motion sensor is arranged to sense the operator's movements in a reference whereof the origination point is the point of entry into a patient's body of a trocar that allows the passage of a surgical instrument, held by the operator.

Such a feature makes it possible to obtain a particularly ergonomic and intuitive control device. Indeed, placing the origin of the reference in which the sensor senses the surgeon's movements at the point of entry of a trocar of a surgical instrument held by the surgeon gives the latter the impression of holding the surgical instrument held by the mounting arm in the hand. In this way, the surgeon performs movements identical to those he would perform if he were holding the surgical instrument held by the mounting arm in his hand. Thus, controlling the movements of the surgical instrument is done without a conscious effort by the surgeon, which allows him to focus solely on the surgical operation in itself and not on the camera's movement. This feature is even more advantageous if the sensor is for example placed on the wrist of the surgeon's arm holding the trocar.

According to another feature of the invention, the means for starting and stopping the detection of the operator's movements comprises means for voice or sound control, said means being arranged to start the detection of the operator's movements by the sensor and the corresponding movement of the mounting arm when said voice or sound control means receives a first predefined voice or sound instruction and to stop the detection of the operator's movements and the movement corresponding to the mounting arm when said voice or sound control means receive a second predefined voice or sound instruction.

The combination of movement detection and a starting voice or sound command makes it possible to obtain an effective control device. Indeed, the movement detection makes it possible to precisely and simply position the instrument in the desired location. The voice or sound control makes it possible to start the detection of movement simply, without adding bulky material in the operating room. Furthermore, the number of voice instructions is reduced because the voice or sound control is only used for a limited number of actions, such as the starting and stopping of the detection of the surgeon's movements. Thus, the voice recognition can easily be implemented and the risk of errors in the interpretation of the commands is decreased.

According to other features of the control device:
the mounting arm can move with four degrees of freedom, the sensor being arranged to sense the operator's movements in at least said four degrees of freedom;
the sensor is an electromagnetic sensor with six degrees of freedom able to detect movements along three axes of translation and three axes of rotation;
the processing means are arranged to transmit control signals identical to the signals emitted by the sensor, the mounting arm identically reproducing the movements sensed by the sensor;
the processing means are also arranged to transmit amplified control signals, reduced or inverted relative to the signals emitted by the sensor, the control arm performing movements with an amplitude proportional to the amplitude of the movements sensed by the sensor according to a predefined proportionality ratio;
the selection between the transmission of identical control signals and the transmission of amplified control signals, reduced or inverted, is done using at least one predefined voice or sound instruction;
the mounting arm moves at a speed identical to the speed of the movements sensed by the sensor or at a speed modulated relative to said movements;
the choice between identical speed or modulated speed is made using a predefined voice or sound command;
the voice or sound control means comprise a microphone receiving voice instructions and voice recognition software; and
the control device comprises means for fastening the sensor to part of the operator's body, in particular the operator's wrist, the sensor being arranged to sense the movements of said body part.

The invention also relates to a surgical operation system, comprising at least one trocar of a surgical instrument intended to be held by the operator and to be introduced into a patient's body and at least one auxiliary surgical instrument supported by a mounting arm, said system comprising a control device for controlling the movement of the auxiliary surgical instrument as described above.

According to another feature of the operating system, the trocar comprises an introduction point, said introduction point being intended to be the point of entry of the trocar into a patient's body, the motion sensor is arranged to sense the operator's movements in a reference whereof the point of origin is the introduction point of the trocar.

Other aspects and advantages of the invention will appear upon reading the following description, provided as an example and in reference to the appended drawings, in which:

FIG. 1 is a diagrammatic perspective illustration of an operating room in which the control device according to the invention is put into place,

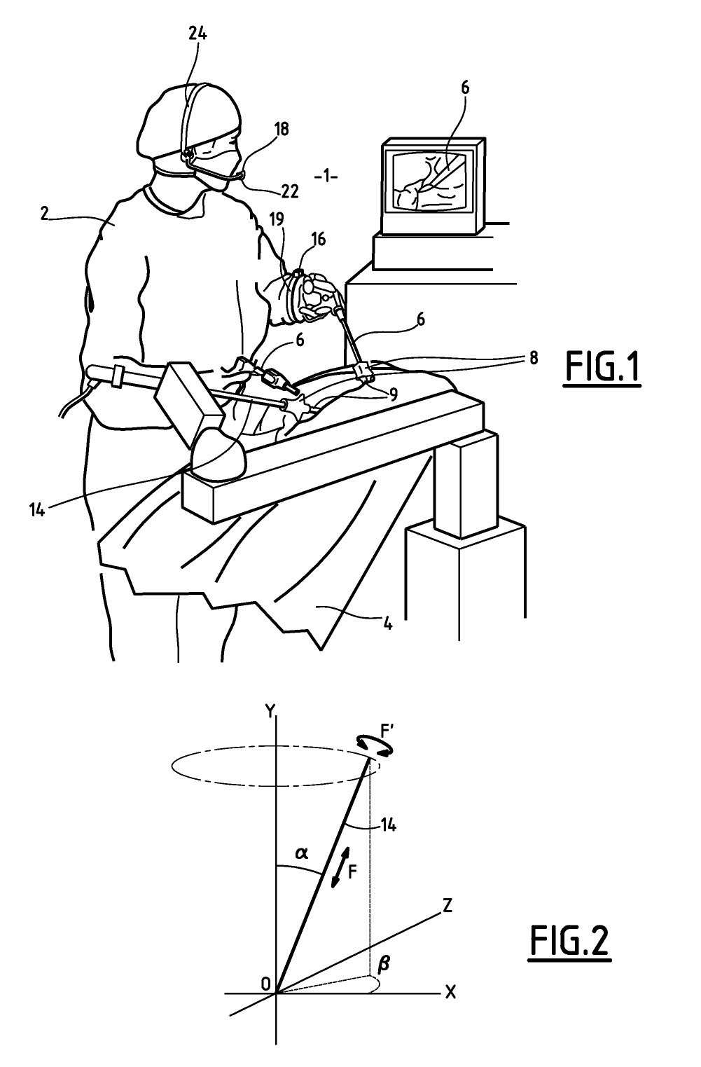

FIG. 2 is a diagrammatic illustration of a reference showing the degrees of freedom of movement of the surgical instrument controlled by the control device according to the invention,

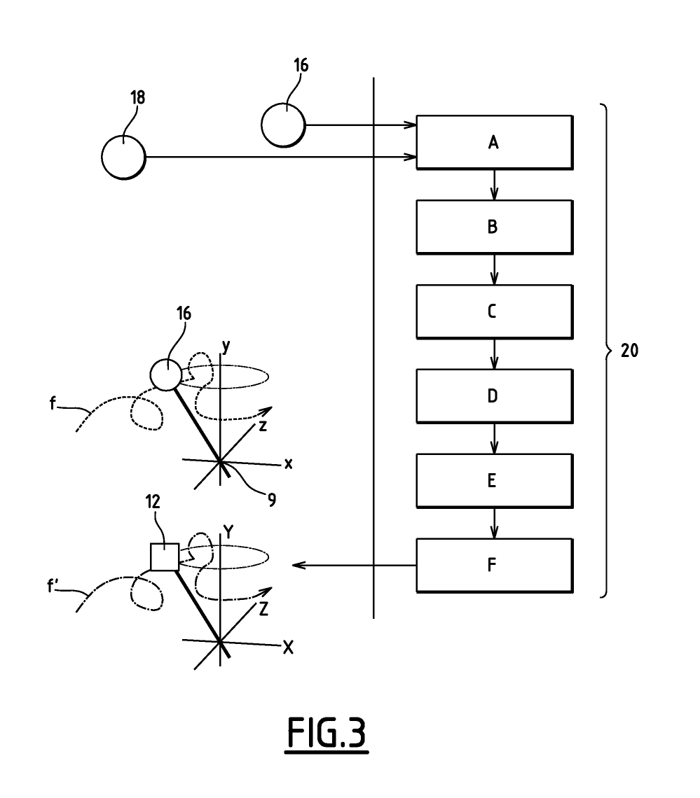

FIG. 3 is a diagram showing the control chain of the control device according to the invention.

FIG. 1 shows an operating room 1 in which a surgeon 2 or operator is performing a minimally invasive surgical operation on a patient 4. To that end, the surgeon 2 uses both hands to manipulate surgical instruments 6 introduced into the patient's body 4 using trocars 8 passing through incisions (not shown) formed in the patient 4. Each trocar 8 comprises an introduction point 9 arranged on the length of the trocar 8 and corresponding to the point of entry of the trocar 8 in the patient's body 4.

In order to visualize the operating zone in which the surgical instruments act, a lens connected to a camera (not shown) is also introduced into the patient's body via a trocar 8. The camera projects images of the operating zone on a monitor 10, which allows the surgeon 2 to visualize the action of his instruments in the operating zone.

Both of the surgeon's hands 2 being taken up by the surgical instruments 6, the camera is supported by a robotic mounting arm 12, or performing robot, whereof the movements are controlled by the surgeon 2, as will be described later. The mounting arm 12, or lens-holder robot, is known in itself and will not be described in more detail here. It is articulated so as to allow the camera to move with several degrees of freedom, as shown in FIG. 2.

This figure shows a reference X, Y, Z whereof the origin O is the introduction point of an auxiliary surgical instrument 14 in the patient's body. The plane defined by axes X-Z substantially represents the surface of the patient's body, and the Y axis is an axis substantially perpendicular to the patient's body at the introduction point O. The instrument 14 is for example a camera. FIG. 2 shows the movement possibilities of the instrument 14 in the reference X, Y, Z. The instrument 14 can move with four degrees of freedom.

The first degree of freedom is shown by the double arrow F in FIG. 2 and is a translational movement along the axis of the instrument 14, i.e. a pushing in or withdrawal of the instrument 14 relative to the origin O.

The second degree of freedom is shown by the angle α of FIG. 2 and is an incline of the instrument 14 relative to the Y axis. By inclining the instrument 14 more or less, the end portion of this instrument is at a more or less substantial height inside the patient's body. This degree of freedom therefore represents an ascending or descending movement of the instrument 14 relative to the patient's body 4.

The third degree of freedom is shown by the angle β of FIG. 2 and is a rotational movement around the Y axis.

The fourth degree of freedom is shown by the arrow F′ of FIG. 2 and is a rotation of the instrument 14 around its own axis, i.e. a rotation of the instrument around itself.

The mounting arm 12 is therefore arranged and articulated to allow the camera to move with the four degrees of freedom described above.

We will now describe the control device for controlling the movement of the camera using the mounting arm 12 described above.

This device comprises, aside from the mounting arm 12, at least one motion sensor 16 and a voice or sound control means 18, as well as a means 20 for processing signals emitted by the motion sensor 16 and the voice or sound control means 18.

The motion sensor 16 is arranged to sense the surgeon's movements with the degrees of freedom of the mounting arm 12 in a reference x, y, z relative to the surgeon (FIG. 3). The motion sensor 16 is placed on part of the surgeon's body making it possible to produce movements with the degrees of freedom of the mounting arms 12. To that end, the motion sensor 16 is for example positioned on the surgeon's wrist, as shown in FIG. 1. The positioning of the sensor 16 on the wrist allows the surgeon to perform intuitive movements when he manipulates his instruments 6 to pilot the movement of the camera, as will be described later. In particular, the positioning of the sensor 16 on the wrist allows the surgeon (due to the autonomy of movement of the wrist relative to the hand) to move the auxiliary instrument 14 without necessarily moving the trocar 8 held by the surgeon's arm relative to the wrist, i.e. the surgeon's hand holding the trocar 8 does not necessarily move while the surgeon performs movements of the wrist to move the camera.

The motion sensor 16 is for example an electromagnetic sensor with six degrees of freedom able to detect movements along three axes of translation and three axes of rotation. This sensor 16 is for example a “flock of birds” sensor marketed by the company Ascension Technology Corporation. The sensor 16 is fastened to the surgeon's wrist 2 by fastening means 19, for example of the watch bracelet or scratch bracelet type. According to other embodiments, the motion sensor 16 is placed on other parts of the surgeon's body, such as the head inter alia.

The voice or sound control means 18 comprise a microphone 22 and voice recognition software programmed to recognize predefined voice instructions spoken into the microphone 22 by the surgeon 2. The microphone 22 is for example arranged on a headset 24 worn by the surgeon and arranged to place the microphone near the latter's mouth.

The processing means 20 are for example formed by electronic means and computer software programmed appropriately to perform the signal transmissions and the different processing steps described below.

The operation of the control device will now be described relative to FIG. 3.

When the surgeon 2 wishes to move the camera and therefore actuate the movement of the mounting arm, he says a first predefined voice or sound instruction into the microphone 22. This first voice or sound instruction, for example “go” or “start,” is recognized by the voice recognition software, which transmits a corresponding signal to the processing means 20. During step A, the detection of the surgeon's movements by the sensor 16 is then initiated. It should be noted that the detection by the sensor 16 is only initiated by the pronouncement of the first predefined voice or sound instruction, i.e. the surgeon's movements are only taken into account when the latter wishes, which avoids continuous movement of the camera during movements by the surgeon.

The surgeon performs movements of the wrist as shown by arrow f of FIG. 3. These movements are sensed by the sensor 16 during a step B. The movements are sensed relative to a reference x, y, z relative to the surgeon. The point of origin of this reference is advantageously the introduction point 9 of the trocar 8, i.e. the entry point of the trocar 8 of the surgical instrument 6 held by the surgeon in the patient's body.

Choosing the point of origin of the reference x, y, z as the introduction point 9 makes it possible to give the surgeon the impression of holding the camera in his hand even when it is held by the mounting arm 12. As previously mentioned, this makes controlling the movements of the camera particularly intuitive and ergonomic, the surgeon not needing to make a conscious effort to resituate the camera in the reference X, Y, Z in which it moves.

Alternatively, the point of origin of the reference x, y, z is for example the point where the sensor 16 is located when the first voice or sound instruction is spoken or another fixed point chosen in the perimeter of the operation and set before the operation.

The sensor 16 emits path signals corresponding to the movement of the sensor 16 in the reference x, y, z towards the processing means 20.

It will be noted that positioning the sensor 16 on the wrist is more intuitive, because the surgeon 2 can manipulate the surgical instruments he is holding while ensuring movement of the camera through movements of the wrist ensuring the manipulation of the camera. Thus, the camera is “naturally” placed in the desired location without the surgeon needing to make a conscious effort to ensure this positioning.

During a step C, the signals emitted during step B are analyzed and converted into coordinates in reference x, y, z of the sensor 16.

During a step D, the coordinates thus obtained are associated with, or converted into, corresponding movement coordinates of the mounting arm 12 relative to its own reference X, Y, Z.

During a step E, the movement coordinates of the mounting arm 12 are converted into path data in order to adapt these movements to the driving capacities of the mounting arm.

During a step F, the movement orders adapted to the driving capacities of the mounting arm are transmitted to it via control signals.

The mounting arm 12 then performs the movements corresponding to the surgeon's movements as shown by arrow f′ in FIG. 3.

When the camera placement is satisfactory for the surgeon, the latter speaks a second predefined voice or sound instruction, for example “stop,” into the microphone 22, which interrupts the detection of the movements made by the surgeon 2 and immobilizes the camera.

It will be noted that the voice instructions are preferably simple and concise, which facilitates programming of the voice recognition software and prevents interpretation errors. In order to avoid complex programming of this software and limit the risk of errors, the number of predefined voice instructions is also reduced. However, other voice instructions can be provided so as to adjust the behavior of the mounting arm 12 as a function of the movements by the surgeon 2.

For example, the speed and amplitude of movement of the mounting arm 12 can be modulated by associating various degrees of amplification with the surgeon's movements. For example, the processing means 20 are arranged to transmit control signals identical to the signals emitted by the sensor 16, the mounting arm 12 then identically reproducing the movements sensed by the sensor 16, or to transmit amplified or reduced control signals, and/or accelerated or slowed control signals, relative to the signals emitted by the sensor 16, the control arm 12 then performing movements with an amplitude and/or speed proportional to the amplitude and/or speed of the movements sensed by the sensor 16 according to a predefined proportionality ratio.

The selection of the degree of amplification of the movements sensed by the sensor 16 is done using predefined voice instructions, for example “profile 1,” “profile 2,” etc., each profile, previously recorded in the processing means 20, corresponding to a degree of amplification making it possible to modulate the amplitude and/or speed of movements of the mounting arm.

According to another embodiment, different degrees of amplification according to the degrees of freedom are provided so as to modulate the amplitude and/or speed of movement of the mounting arm 12 according to these degrees of freedom. For example, it is provided for the speed of rotation of the camera around its axis to be greater than the speed of translation of the camera along its axis. These degrees of amplification are selected using predefined voice instructions.

Alternatively, the choice of degrees of amplification will be made by inputs in the computer software, for example using a keyboard, which limits the number of voice instructions to be taken into account.

According to one particular alternative, an “inverted” profile may be chosen. In this profile, the movements made by the surgeon to control the movement of the camera are reproduced, inverted, by the mounting arm 12. Therefore, if the surgeon moves his wrist to the right for example, the camera will move to the left. Such a profile is advantageous when the trocar supporting the camera is arranged opposite the surgeon. In fact, the camera then “mirrors” the movements made by the sensor 16 carried by the surgeon.

Other voice instructions can be provided, such as instructions relative to the camera's focus, which makes it possible to zoom in on the operating area. Alternatively, the surgeon's movement corresponding to the degree of freedom of the camera's translation along its axis is interpreted as being a request to change the focus, i.e. a movement by the surgeon in this degree of freedom does not cause the camera to move with this degree of freedom, but causes a focus change of the camera. Thus, the closer the surgeon's arm comes to the point of origin of the reference, the more the camera zooms in on the operating area and conversely, the farther the surgeon's arm is from the point of origin, the wider the field of the operating zone offered by the camera.

It is also possible to provide for recording a particular position of the camera and a voice or sound instruction making it possible to automatically resituate the camera in this recorded position.

According to alternative embodiments, the means for starting and stopping detection of the sensor 16 are done other than by voice. It is therefore possible to provide for the surgeon to start the detection by a particular instrument, such as a whistle, for example ultrasonic, whereof one whistle starts the detection and two whistles, or a second whistle, stops it. Likewise, the detection could be initiated by tapping the foot if the microphone is positioned accordingly, or by pushing a button or other means.

The mounting arm 12 can also be disengaged, i.e. its movements are no longer managed by the control device, but are done manually, for example by an assistant.

The device described above is particularly simple to implement and allows precise positioning of the camera by the surgeon without the latter having to let go of his instruments 6 or interrupt his operation. Moreover, the voice or sound control of the initiation of taking the surgeon's movements into account and the simplification of the transmitted instructions make it possible to limit the elements in the operating room and to simplify the surgeon's work regarding the placement of the camera, the surgeon then being able to focus solely on the operation he is performing.

Although the description was done relative to the position of a camera, it will be understood that it can apply to controlling the movement of any type of surgical instrument supported by a robotic mounting arm. The control device can in particular be used to control the movement of an imaging device or setting instruments, for example.

The assembly formed by the trocars 8 supporting the surgical instruments 6 held by the surgeon and the auxiliary instrument 14 supported by the mounting arm 12 as well as the control device described above forms an operating system.

1-14. (canceled)

15. A device for controlling the movement of a surgical instrument, of the type comprising a mounting arm (12) of the instrument and at least one motion sensor (16), said arm (12) being able to move with at least one degree of freedom, said motion sensor (16) being intended to be positioned on the operator (2) of the control device and being arranged to sense the movements of said operator according to the degree of freedom of the mounting arm (12), said deice comprising means (20) for processing signals emitted by the motion sensor (16), said means (20) being arranged to process the signals emitted by the motion sensor (16) and to transmit corresponding control signals to the mounting arm (12) so that the movements sensed by the motion sensor (16) control corresponding movements of the mounting arm (12), characterized in that it also comprises means for starting and stopping the detection of the operator's movements by the sensor (16).

16. The control device according to claim 15, characterized in that the motion sensor (16) is arranged to sense the operator's movements in a reference (x, y, z) whereof the origination point is the point of entry into a patient's body of a trocar (8) that allows the passage of a surgical instrument (6), held by the operator, into a patient's body.

17. The control device according to claim 15, characterized in that the means for starting and stopping the detection of the operator's movements comprises voice or sound control means (18), said means (18) being arranged to start the detection of the operator's movements by the sensor (16) and the corresponding movement of the mounting arm (12) when said voice or sound control means (18) receives a first predefined voice or sound instruction and to stop the detection of the operator's movements and the movement corresponding to the mounting arm (12) when said voice or sound control means receive a second predefined voice or sound instruction.

18. The control device according to claim 15, characterized in that the mounting arm (12) can move with four degrees of freedom, the sensor (16) being arranged to sense the operator's (2) movements in at least said four degrees of freedom.

19. The control device according to claim 18, characterized in that the sensor (16) is an electromagnetic sensor with six degrees of freedom able to detect movements along three axes of translation and three axes of rotation.

20. The control device according to claim 15, characterized in that the processing means (20) are arranged to transmit control signals identical to the signals emitted by the sensor (16), the mounting arm (12) identically reproducing the movements sensed by the sensor (16).

21. The control device according to claim 20, characterized in that the processing means (20) are also arranged to transmit amplified control signals, reduced or inverted relative to the signals emitted by the sensor (16), the control arm (16) performing movements with an amplitude proportional to the amplitude of the movements sensed by the sensor (16) according to a predefined proportionality ratio.

22. The control device according to claim 21, characterized in that the selection between the transmission of identical control signals and the transmission of amplified control signals, reduced or inverted, is done using at least one predefined voice or sound instruction.

23. The control device according to claim 15, characterized in that the mounting arm (12) moves at a speed identical to the speed of the movements sensed by the sensor (16) or at a speed modulated relative to said movements.

24. The control device according to claim 23, characterized in that the mounting arm moves at a speed identical to the speed of the movements sensed by the sensor or at a speed modulated relative to said movements.

25. The control device according to claim 15, characterized in that the voice or sound control means (18) comprise a microphone (22) receiving voice instructions and voice recognition software.

26. The control device according to claim 15, characterized in that it comprises means (19) for fastening the sensor (16) to part of the operator's body (2), in particular the operator's wrist (2), the sensor (16) being arranged to sense the movements of said body part.

27. A surgical operation system, comprising at least one trocar (8) of a surgical instrument (6) intended to be held by the operator and to be introduced into a patient's body and at least one auxiliary surgical instrument (14) supported by a mounting arm (12), characterized in that said system comprises a control device for controlling the movement of the auxiliary surgical instrument (14) according to claim 15.

28. The operating system according to claim 27, characterized in that the trocar (8) comprises an introduction point, said introduction point being intended to be the point of entry of the trocar (8) into a patient's body, the motion sensor (16) is arranged to sense the operator's movements in a reference (x, y, z) whereof the point of origin is the introduction point of the trocar (8).

29. The control device according to claim 16, characterized in that the means for starting and stopping the detection of the operator's movements comprises voice or sound control means (18), said means (18) being arranged to start the detection of the operator's movements by the sensor (16) and the corresponding movement of the mounting arm (12) when said voice or sound control means (18) receives a first predefined voice or sound instruction and to stop the detection of the operator's movements and the movement corresponding to the mounting arm (12) when said voice or sound control means receive a second predefined voice or sound instruction.

30. The control device according to claim 16, characterized in that the mounting arm (12) can move with four degrees of freedom, the sensor (16) being arranged to sense the operator's (2) movements in at least said four degrees of freedom.
